(19) United States
(12) Patent Application Publication
(10) Pub. No.: US 2010/0052511 A1
(43) Pub. Date: Mar. 4, 2010

(54) FIELD EMISSION DEVICE

(76) Inventor: Till Keesmann, Heidelberg (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/514,765

(22) PCT Filed: Nov. 15, 2007
(86) PCT No.: PCT/DE07/02065

§ 371 Date: May 13, 2009

(30) Foreign Application Priority Data
Nov. 15, 2006 (DE) 10 2006 054 206.1

(51) Int. Cl. H01J 1/62

(52) U.S. Cl. 313/496

(57) ABSTRACT

The invention relates to a field emission device comprising a cathode having an emission region (1) for electrons (2). The field emission device is embodied for generating technically useful electron currents at a voltage which is as low as possible, in such a way that the emission region (1) has an arrangement of a plurality of individually positioned or positionable atoms (4) or molecules.

The invention relates to a field emission device having a cathode, which has an emission area for electrons.

A field emission device of the type cited at the beginning is known, for example, from U.S. RE 38,561 E. In the known field emission device, a carbon nanotube is used as the emission area.

In field emission, electrons are emitted from a cathode under the action of a high electrical field. High electrical fields occur in particular in cathode areas having small radii of curvature.

For technological applications of a field emission device, it is desirable to implement the lowest possible voltages, the highest possible field strengths, and thus the highest possible current density of the emission current in the emission area of the cathode.

The present invention is therefore based on the object of specifying a field emission device, using which technically usable electronic currents may be implemented with the least possible voltage.

According to the invention, the preceding object is achieved by a field emission device having the features of Claim 1. A field emission device is accordingly implemented in such a way that the emission area has a configuration made of multiple individually positioned or positionable atoms or molecules.

It has been recognized in a way according to the invention that emission areas suitable for field emission may be generated in that individual atoms or molecules are situated in a suitable way to form an emission area. Emission areas of this type typically have very small radii of curvature. This has the result that technically usable electronic currents may be emitted from the cathode using very small electrical voltages. Positioning of individual atoms may be performed using the means known from scanning tunneling microscopy.

In regard to a particularly stable configuration of the atoms or molecules, the atoms or molecules may be situated in a crystal structure. A stable and uniform emission of electrons may thus be maintained over a long period of time.

In regard to a particularly reliable field emission device, the atoms, molecules, or crystals may be situated on a carrier. A carrier of this type allows secure handling of the entire field emission device.

To provide a particularly mechanically stable carrier, the carrier may comprise glass, silicon, carbon, rhodium, tantalum, palladium, palladium oxide, aluminum, a quartz material, a ferroelectric material, a ferromagnetic material, or a preferably conductive ceramic. For example, zinc oxide doped using aluminum—Al:ZnO—suggests itself as the conductive ceramic. An embodiment of the carrier of this type further offers a high vacuum stability during the operation of the field emission device. If a carrier which has a ferroelectric material is used, the ferroelectric material may comprise barium titanate, for example.

In an alternative embodiment, the carrier may comprise a plastic or be implemented completely from plastic. In particular polyaniline, polypyrrole, or polyphenylene amine suggest themselves as the plastics as a component of the carrier or as the carrier material as a whole. Very generally, organic metals which have several properties characteristic to metals may be used as the carrier material or as a component of the carrier. In contrast to conventional metals, nanoeffects still occur in this case. In particular, all primary particles of the various conductive plastics have a diameter of significantly less than 20 nm. Particles of this type spontaneously form extremely fine chains and networks from critical concentrations in a dispersion.

To ensure a space-saving configuration and a space-saving use of the field emission device, the cathode may be implemented as rod-shaped or disk-shaped. With a design of this type, multiple cathodes may be situated in an extremely small space.

Depending on the requirements, at least one of the atoms or molecules may be selected in such a way that it has conductor or semiconductor properties at least under a predefinable environmental condition. Individual emission areas may thus be formed in particular.

At least one of the atoms may be a metal atom, embodiments of the field emission device fundamentally suggesting themselves in which at least one of the atoms is an iron, magnesium, copper, potassium, platinum, silver, palladium, or gold atom. The particular application of the field emission device is also to be considered here in the selection of the suitable material.

As a further alternative, at least one of the atoms may be a carbon atom. More recently, embodiments of the emission areas in the form of carbon nanotubes have particularly been shown to be very advantageous in regard to reliable emission of electrons. The configuration of the emission area may thus particularly advantageously be converted into a carbon nanotube.

Different embodiments of the emission area in combination with nanotubes, for example, are also advantageous here depending on the application. Specifically, one or more carbon atoms or nanotubes may be bonded to composite materials or be provided in the meaning of bonded nanoparticles or nanocomposites.

Carbon nanotubes may be produced in a particularly reliable way by different deposition methods. Plasma-induced and electron-beam-induced deposition—PECVD and EBID (electron-beam-induced deposition)—suggest themselves in this case.

In a concrete embodiment, the configuration may essentially have the form of an n-sided pyramid. The pyramids may be regular or irregular, for example, they may have a trapezoidal base.

In a further embodiment, the configuration may essentially have the form of a truncated pyramid. It is only to be ensured that a sufficiently small radius of curvature is implemented for reliable emission of electrons with the lowest possible voltage.

In a further alternative embodiment, the configuration may essentially have the form of a preferably regular polyhedron. The form of a cube or very generally a cuboid is also conceivable.

An embodiment suitable for the field emission may also be implemented in that the configuration essentially has the form of a cone or preferably a right circular cone or a cylinder. With a conical embodiment of the configuration as the basic shape, the configuration may essentially have the form of a truncated cone.

In the ideal case, a single atom or molecule may form a tip of the emission area. Depending on the application, multiple individual atoms or molecules may preferably form a narrow tip, edge, or corner.

The emission area does not necessarily have to comprise only one chemical element. Rather, it is also conceivable that at least two different types of atoms or molecules are situated in the emission area. A positive effect in regard to a reliable field emission may be provided in particular by the interaction of different chemical elements.

In a practical application, the field emission device according to the invention may be usable for ionizing gases, in a field emission microscope, in a scanning tunneling microscope, or in an atomic force microscope. Furthermore, the field emission device according to the invention may be used in the field of lights or illuminants or backlight. Furthermore, it is possible to use the field emission device on circuit boards, in the field of microelements, microdevices, or in the field of data carriers. Furthermore, an application in the field of measuring sensors, in the field of hand-held x-ray fluorescence analysis devices, in x-ray devices, and in the field of computer tomography is conceivable.

Because of the simple handling and the small size of the field emission device according to the invention, multiple individual field emission devices may be situated in an extremely small space. Specifically, multiple cathodes may be situated in one line or in one plane, so that a linear or planar electron source is formed—by multiple individual emitters. An irregular and random configuration of the cathodes or also a symmetrical configuration may be performed. The particular use is to be taken into consideration.

Specifically, multiple cathodes may be situated in a plane in the form of a matrix. A symmetrical configuration of individual cathodes may be implemented for this purpose.

If multiple cathodes are provided, the individual cathodes may be activatable individually or in groups. For this purpose, it may be taken into consideration whether the electron current of a single cathode is sufficient for the desired application, or whether only multiple cathodes in combination form a sufficient electron current. In the latter case, an ability to activate the cathodes in groups may be advantageous.

In an especially advantageously embodiment, the cathodes may each be implemented as an electron source for pixels of an optical display or a display screen. Computer or TV display screens are considered in particular for this purpose. In this case, an anode for attracting the emitted electrodes may be situated opposite to the emission area. Particularly reliable guiding of the emitted electrons to the desired location is achieved in this way.

Specifically, the anode may have an electrically conductive material or may be implemented from a material of this type. A reliable relay of emitted electrodes may be performed via the anode in this way.

To implement a device in which the anode is only used as a functional element for attracting electrons, the anode may comprise a material permeable to electrons. Electrons emitted from the emission area of the cathode may be accelerated toward the anode in this case and then pass through the anode for a further application. An embodiment of this type would be advantageous in particular to implement a display or TV display screen, the electrodes being able to be incident on a fluorescent material through the anode.

In a concrete embodiment, the anode may comprise a metal or a preferably conductive plastic. The material selection of the anode may be performed in consideration of a high vacuum resistance.

Specifically, the metal may be aluminum, copper, or tungsten. Alternatively or additionally thereto, the anode may comprise polyaniline, polypyrrole, or polyphenylene amine or be constructed from these plastics. Fundamentally, organic metals may be used here, as have already been described above in connection with the material of the emission area.

To implement an anode which is effective in attracting the electrons and nonetheless space-saving, the anode may be formed by a thin layer or a thin film. A thin layer or a thin film of this type may be at least sectionally applied on a fluorescent material. A TV display screen may be implemented having a simple design in this way.

In an alternative embodiment, the anode may be implemented as an admixture in a fluorescent material. In this case, a particularly effective interaction between the emitted electrons, which are incident on the fluorescent material, is ensured without interference effects by a layer-type or film-type anode situated in front of the material. In other words, the electrons may be incident directly on the fluorescent material and generate a fluorescence effect. A reliable attracting action for the electrons may nonetheless be ensured by the anode in this case. An admixture of anode material into the fluorescent material may be performed in a liquid phase of the particular materials in each case. Alternatively thereto, solid particles of the anode materials may also be mixed into a liquid or powdered fluorescent material. Sintering may subsequently be performed, to obtain a quasi-solid body made of anode material and fluorescent material.

In an especially advantageously embodiment, the fluorescent material may have an admixture made of a material which conducts and/or attracts electrons. In this way, an attraction of the electrons and/or a secure dissipation of the incident electrons via the fluorescent material are ensured.

Specifically, the material which conducts and/or attracts electrons may comprise a metal. However, organic metals also come into consideration as materials which conduct electrons.

An anode implemented as described above may also be used with other, previously known field emission devices or other electron emission devices. There is no required connection of the described anode with a field emission device as described in Claim 1 in this case. The advantages of the embodiment of the previously described anode are partially or even completely achievable even using other electron sources. For example, a use of the previously described anode may also occur together with an SCE—surface-conduction electron emitter, as is used, for example, in an SED—surface-conduction electron-emitter display.

In the field emission device according to the invention, spherical, disk-shaped, or rod-shaped particles may be provided in the emission area. Furthermore, metal particles, semiconductor particles, polymer particles, or ceramic particles may be provided. Finally, nanoparticles or fibrous particles and combinations of all above-mentioned particles may also be provided.

There are now various possibilities for advantageously implementing and refining the teaching of the present invention. For this purpose, reference is made, on the one hand, to the subordinate claims, and, on the other hand, to the following explanation of two exemplary embodiments of the field emission device according to the invention. Generally preferred embodiments and refinements of the teaching are also explained in connection with the explanation of the preferred exemplary embodiments on the basis of the drawing. In the figures:

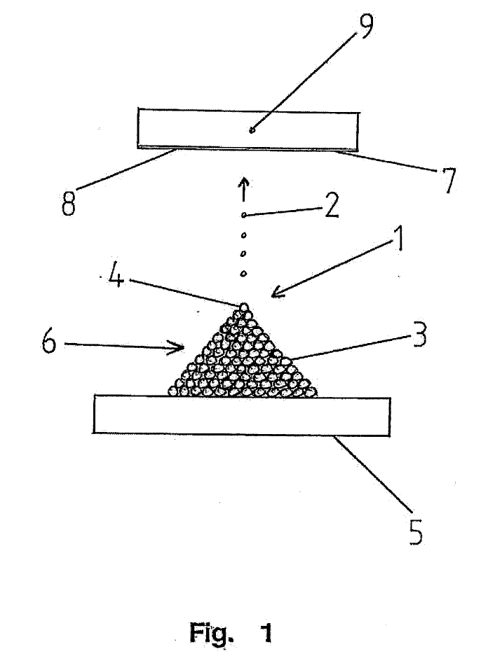

FIG. 1 shows a schematic side view of a first exemplary embodiment of a field emission device according to the invention and

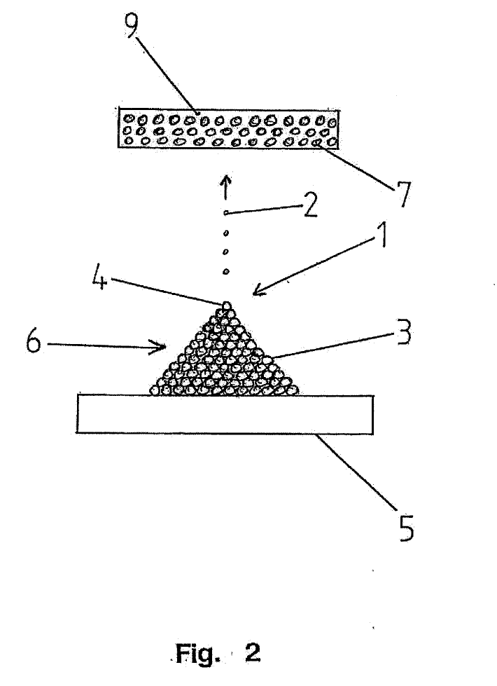

FIG. 2 shows a schematic side view of a second exemplary embodiment of a field emission device according to the invention.

FIG. 1 shows a schematic side view of a first exemplary embodiment of a field emission device according to the invention having a cathode 3, which comprises an emission area 1 for electrons 2. The emission area 1 has a configuration made of multiple individually positioned or positionable atoms 4. The configuration made of atoms 4 is situated on a carrier 5, which may comprise glass, silicon, or plastic, for example.

The configuration made of atoms 4 essentially has the shape of a four-sided pyramid 6. A single atom 4 forms a tip of the emission area 1. Electrons 2 are emitted from the tip in the direction of an anode 7.

The anode 7 is implemented as a thin film 8 and applied to a fluorescent material 9. A voltage, which allows the field emission and thus the acceleration of the electrons 2 in the direction of the anode 7, acts between the cathode 3 and the anode 7. The electrons incident on the fluorescent material 9 trigger a light emission in the fluorescent material 9. The field emission device shown in FIG. 1 may be used in the production of a TV display screen.

FIG. 2 shows a schematic side view of a second exemplary embodiment of a field emission device according to the invention. In the second exemplary embodiment shown in FIG. 2, only the anode 7 is implemented differently from the first exemplary embodiment shown in FIG. 1. Otherwise, the construction of the atoms 4 positioned on the carrier 5 corresponds to the exemplary embodiment shown in FIG. 1.

In the second exemplary embodiment, the anode 7 is implemented as an admixture in a fluorescent material 9. Specifically, for example, metallic particles may be mixed into the fluorescent material 9, to form a quasi-integrated anode 7 in the fluorescent material 9.

Reference is made to the general part of the description and to the appended patent claims in regard to further advantageous embodiments of the field emission device according to the invention to avoid repetitions.

Finally, it is expressly noted that the exemplary embodiments described above are only used to explain the claimed teaching, but do not restrict this teaching to these exemplary embodiments.

1-39. (canceled)

40. A field emission device having a cathode (3), which comprises an emission area (1) for electrons (2), wherein the emission area (1) comprises a configuration made of multiple individually positioned or positionable atoms (4) or molecules and wherein an anode (7) for attracting the emitted electrons (2) is situated opposite to the emission area (1), characterized in that the anode (7) is implemented as an admixture in a fluorescent material (9).

41. The device according to claim 40, characterized in that the atoms (4) or molecules are situated in a crystal structure.

42. The device according to claim 40, characterized in that the atoms (4), molecules, or crystals are situated on a carrier (5).

43. The device according to claim 42, characterized in that the carrier (5) comprises glass, silicon, carbon, rhodium, tantalum, palladium, palladium oxide, aluminum, a quartz material, a ferroelectric material, a ferromagnetic material, or a preferably conductive ceramic, preferably Al:ZnO.

44. The device according to claim 43, characterized in that the ferroelectric material comprises barium titanate.

45. The device according to claim 42, characterized in that the carrier (5) comprises a plastic.

46. The device according to claim 42, characterized in that the carrier (5) comprises polyaniline, polypyrrole, or polyphenylene amine.

47. The device according to claim 40, characterized in that the cathode (3) is implemented as rod-shaped or disk-shaped.

48. The device according to claim 40, characterized in that at least one of the atoms (4) or molecules has conductor or semiconductor properties at least under a pre-definable environmental condition.

49. The device according to claim 40, characterized in that at least one of the atoms (4) is a metal atom.

50. The device according to claim 40, characterized in that at least one of the atoms (4) is an iron, magnesium, copper, potassium, platinum, silver, palladium, or gold atom.

51. The device according to claim 40, characterized in that it least one of the atoms (4) is a carbon atom.

52. The device according to claim 40, characterized in that the configuration is converted into a carbon nanotube.

53. The device according to claim 52, characterized in that one or more carbon atoms or nanotubes are bonded to composite materials or are provided in the meaning of bonded nanoparticles or nanocomposites.

54. The device according to claim 40, characterized in that the configuration essentially has the form of an n-sided pyramid (6).

55. The device according to claim 54, characterized in that the pyramid (6) is regular or irregular.

56. The device according to claim 40, characterized in that the configuration essentially has the form of a truncated pyramid.

57. The device according to claim 40, characterized in that the configuration essentially has the form of a preferably regular polyhedron.

58. The device according to claim 40, characterized in that the configuration essentially has the form of a cone or preferably a right circular cone or a cylinder.

59. The device according to claim 40, characterized in that the configuration essentially has the form of a truncated cone.

60. The device according to claim 40, characterized in that a single atom (4) or molecule forms a tip of the emission area (1).

61. The device according to claim 40, characterized in that multiple individual atoms (4) or molecules form a preferably narrow tip, edge, or corner.

62. The device according to claim 40, characterized in that at least two different types (4) of atoms or molecules are situated in the emission area (1).

63. The device according to claim 40, characterized in that the field emission device is usable in a field emission microscope, in a scanning tunneling microscope, or in an atomic force microscope.

64. The device according to claim 40, characterized in that multiple cathodes (3) are situated in a line or in a plane, so that a linear or planar electron source is formed.

65. The device according to claim 40, characterized in that multiple cathodes (3) are situated in a plane in the form of a matrix.

66. The device according to claim 64, characterized in that the individual cathodes (3) are activatable individually or in groups.

67. The device according to claim 64, characterized in that the cathodes (3) are each implemented as an electron source for pixels of an optical display or a display screen.

68. The device according to claim 40, characterized in that the anode (7) comprises an electrically conductive material.

69. The device according to claim 40, characterized in that the anode (7) comprises a material permeable to electrons.

70. The device according to claim 40, characterized in that the anode (7) comprises a metal or a preferably conductive plastic.

71. The device according to claim 70, characterized in that the metal is aluminum, copper, or tungsten.

72. The device according to claim 40, characterized in that the anode (7) comprises polyaniline, polypyrrole, or polyphenylene amine.

73. The device according to claim 40, characterized in that the anode (7) is formed by a thin layer or a thin film (8).

74. The device according to claim 73, characterized in that the thin layer or the thin film (8) is at least sectionally applied on a fluorescent material (9).

75. The device according to claim 40, characterized in that the fluorescent material (9) has an admixture made of a material which conducts and/or attracts electrons (2).

76. The device according to claim 75, characterized in that the material which conducts and/or attracts electrons (2) comprises a metal.
